(19) United States
(12) Patent Application Publication
(10) Pub. No.: US 2025/0015836 A1
(43) Pub. Date: Jan. 9, 2025

(54) POWER SUPPLY DEVICE, POWER SUPPLY SYSTEM, AND NON-TRANSITORY COMPUTER-READABLE STORAGE MEDIUM

(71) Applicant: KABUSHIKI KAISHA TOSHIBA, Tokyo (JP)

(72) Inventor: Toshiya MITOMO, Yokohama Kanagawa (JP)

(73) Assignee: KABUSHIKI KAISHA TOSHIBA, Tokyo (JP)

(21) Appl. No.: 18/590,530

(22) Filed: Feb. 28, 2024

(30) Foreign Application Priority Data
Jul. 3, 2023 (JP) 2023-109490

(51) Int. Cl. H04B 5/79; H02J 50/20; H02J 50/90; H04B 5/43

(52) U.S. Cl. CPC H04B 5/79; H02J 50/20; H02J 50/90; H04B 5/43

(57) ABSTRACT

According to one embodiment, a power supply device includes a receiving unit and a power transmitting unit. The receiving unit receives, from a control device, a first control signal including first information that designates a first power receiving device of a plurality of power receiving devices. The power transmitting unit transmits a wireless power transmission signal for power supply to the first power receiving device, based on the first information. The first control signal is a signal which causes the first power receiving device to perform a specific operation.

### CROSS-REFERENCE TO RELATED APPLICATIONS

This application is based upon and claims the benefit of priority from Japanese Patent Application No. 2023-109490, filed Jul. 3, 2023, the entire contents of which are incorporated herein by reference.

### FIELD

Embodiments described herein relate generally to a power supply device, a power supply system, and a non-transitory computer-readable storage medium.

### BACKGROUND

In recent years, power supply devices that supply power wirelessly by using electromagnetic waves (for example, microwaves) has been developed.

A power supply device acquires, for example, from a power receiving device that is a target of power supply, information (location information) indicative of the location of the power receiving device. Based on the acquired location information, the power supply device can supply power to the target power receiving device by radiating electromagnetic waves having directivity to the power receiving device.

In such a case, the power receiving device includes a communication unit for transmitting the location information.

### BRIEF DESCRIPTION OF THE DRAWINGS

FIG. 1 is a block diagram showing a configuration example of a power supply system that includes a power supply device according to a first embodiment.

FIG. 2 is a diagram showing a configuration example of a power supply information table that is used in the power supply device of the first embodiment.

FIG. 3 is a sequence diagram showing a first example of a control operation in the power supply system that includes the power supply device of the first embodiment.

FIG. 4 is a sequence diagram showing a second example of the control operation in the power supply system that includes the power supply device of the first embodiment.

FIG. 5 is a sequence diagram showing a third example of the control operation in the power supply system includes the power supply device of the first embodiment.

FIG. 6 is a block diagram showing a first example of a configuration of the power supply device of the first embodiment.

FIG. 7 is a block diagram showing a second example of the configuration of the power supply device of the first embodiment.

FIG. 8 is a block diagram showing a first example of a configuration of a power receiving device to which power is supplied by the power supply device of the first embodiment.

FIG. 9 is a block diagram showing a second example of the configuration of the power receiving device to which power is supplied by the power supply device of the first embodiment.

FIG. 10 is a block diagram showing a configuration example of a power supply system that includes a power supply device according to a second embodiment.

FIG. 11 is a block diagram showing a configuration example of a power supply system that includes a power supply device according to a third embodiment.

### DETAILED DESCRIPTION

In general, according to one embodiment, a power supply device includes a receiving unit and a power transmitting unit. The receiving unit receives, from a control device, a first control signal including first information that designates a first power receiving device of a plurality of power receiving devices. The power transmitting unit transmits a wireless power transmission signal for power supply to the first power receiving device, based on the first information. The first control signal is a signal which causes the first power receiving device to perform a specific operation.

Various embodiments will be described hereinafter with reference to the accompanying drawings.

### First Embodiment

First, with reference to FIG. 1, a configuration of a power supply system that includes a power supply device according to a first embodiment will be explained. A power supply system 1A is, for example, a system that wirelessly supplies power to a device whose installation location is fixed and causes the device to perform a specific operation. The device with a fixed installation location is, for example, a sensing device, an electronic shelf label, or a pickup display device.

The sensing device is a device that senses physical or chemical information at its installation location and generates data based on the sensed information on physical or chemical quantity (hereinafter, also referred to as sensor data).

The electronic shelf label is a display device that is installed at a location where an item is placed (for example, on a shelf) and electronically displays information on the item. The information on the item is, for example, a name and a price of the item.

The pickup display device is a display and input device that is installed at a location where an item is placed and prompts an operator to pick up the item. The pickup display device indicates whether or not the item needs to be picked up by, for example, turning an LED on and off. The pickup display device, for example, turns on the LED when the corresponding item needs to be picked up, receives an operation (external input) by the operator indicating that the item has been picked up, and then turns off the LED.

The power supply system 1A includes, for example, a control device 11, a power supply device 12, and N power receiving devices 13, where N is an integer of two or more. The N power receiving devices 13 include a first power receiving device 13-1, a second power receiving device 13-2, . . . , and Nth power receiving device 13-N. In the following descriptions, one unspecified power receiving device among the N power receiving devices 13 may be referred to as a power receiving device 13.

The control device 11 is a device (i.e., a parent device) that controls an operation of the power supply device 12 and an operation of each of the N power receiving devices 13. The control device 11 is driven, for example, by electric power supplied from an external power source. Specifically, the control device 11 informs the power supply device 12 and the power receiving devices 13 of the power receiving device 13 that is a target of power supply, and controls the operation of the target power receiving device 13 and the operation of the power supply device 12. The control device 11 transmits a control signal 21 to inform the power supply device 12 and the power receiving devices 13 of the power supply device 13 that is a target of power supply and an operation (hereinafter, also referred to as a target power receiving device 13). The control signal 21 is a radio signal that includes information designating one power receiving device 13 of the N power receiving devices 13. The information designating one power receiving device 13 of the N power receiving devices 13 is, for example, an identification code assigned to the one power receiving device 13 (hereinafter, also referred to as a power receiving device ID). The power receiving device ID is information by which the corresponding power receiving device 13 is uniquely identifiable. The control signal 21 is a signal that causes the designated power receiving device 13 to perform a specific operation and transmit a communication signal 22, for example. The communication signal 22 is a radio signal that includes information on the specific operation.

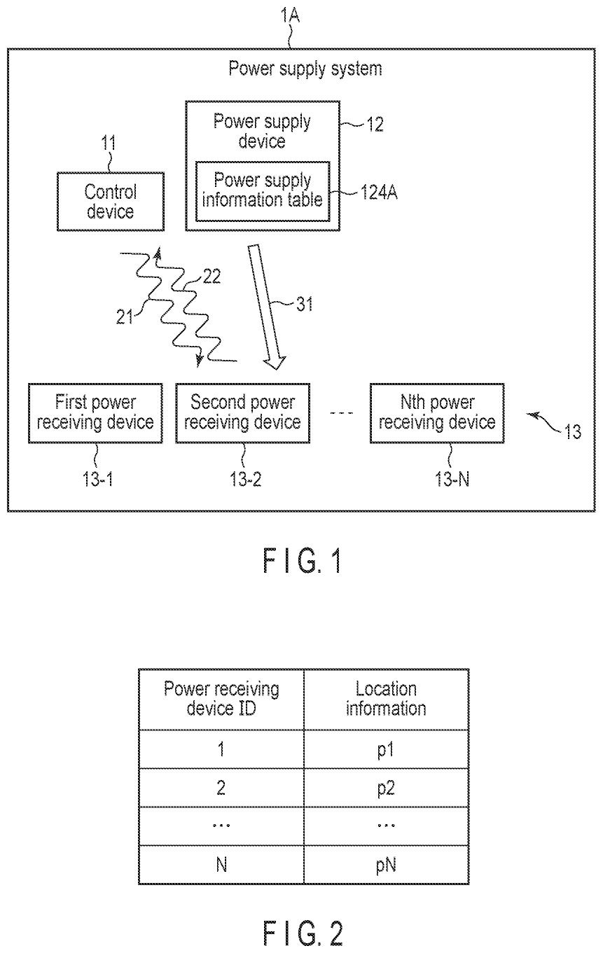

The power supply device 12 is a device that receives the control signal 21 and transmits a power transmission signal 31 to the target power receiving device 13 based on the control signal 21. The power supply device 12 is also referred to as a wireless power transmission device or a power feeder. The power transmission signal 31 is a wireless signal that supplies power to the target power receiving device 13. The power supply device 12 is driven, for example, by electric power supplied from an external power source. The power supply device 12 stores a power supply information table 124A. The power supply information table 124A is data that includes location information of each of the N power receiving devices 13. The power supply device 12 identifies a power receiving device 13 designated in the control signal 21 (that is, the target power receiving device 13). The power supply device 12 acquires the location information of the identified power receiving device 13 from the power supply information table 124A. The power supply device 12 transmits the power transmission signal 31 highly directional to the target power receiving device 13, based on the acquired location information. The specific configuration of the power supply information table 124A will be described later with reference to FIG. 2.

The power receiving device 13 is a device that is driven by power of the power transmission signal 31 transmitted from the power supply device 12 and performs a specific operation based on the control signal 21 transmitted from the control device 11. The power receiving device 13 corresponds to the device whose installation location is fixed as described above. The power receiving device 13 may transmit a communication signal 22 in the specific operation.

FIG. 1 illustrates a case where the target power receiving device 13 is the second power receiving device 13-2. In this case, the control device 11 transmits a control signal 21 that includes information designating the second power receiving device 13-2.

The power supply device 12 receives the control signal 21 from the control device 11, and acquires the location information of the second power receiving device 13-2 from the power supply device information table 124A. The power supply device 12 then transmits a power transmission signal 31 highly directional to the second power receiving device 13-2, based on the acquired location information.

The second power receiving device 13-2 receives the power transmission signal 31 highly directional to the second power receiving device 13-2. The second power receiving device 13-2 is then driven by power of the received power transmission signal 31. The second power receiving device 13-2 receives the control signal 21 from the control device 11 and performs a specific operation. The second power receiving device 13-2 then transmits a communication signal 22 that includes information on the specific operation.

With the above configuration, the power supply device 12 can supply power to the power receiving device 13 designated in the control signal 21 by using the control signal 21 transmitted from the control device 11 and the power supplying information table 124A stored in the power supply device 12, without receiving, from the power receiving device 13, information necessary for power supply. Therefore, the control device 11 and the power supply device 12 do not need to have a function for detecting the location of the power receiving device 13.

Further, for example, if the power receiving device 13 has its location information and transmits the location information to the power supply device 12, the power receiving device 13 must include a battery to drive a communication unit, which transmits the location information, before power is supplied from the power supply device 12.

In contrast, the power supply device 12 of the embodiment identifies the target power receiving device 13 on the basis of the control signal 21 transmitted from the control device 11, and acquires the location information of the identified power receiving device 13 from the power supply device information table 124A. Therefore, the power receiving device 13 does not need to transmit the location information. Further, the power receiving device 13 does not need to have a battery to drive a communication unit, which transmits the location information, before power is supplied from the power supply device 12. Therefore, in the power supply system 1A, the power receiving devices 13 can be downsized and the cost of them can be reduced.

Next, the power supply information table 124A stored in the power supply device 12 will be explained. FIG. 2 shows a configuration example of the power supply information table 124A. The power supply information table 124A includes, for example, entries that correspond to the power receiving devices 13, respectively. Each entry includes a power receiving device ID field and a location information field.

In an entry corresponding to a certain power receiving device 13, the power receiving device ID field indicates an identification code (power receiving device ID) assigned to the power receiving device 13.

The location information field indicates location information corresponding to the power receiving device 13. The location information is, for example, information indicative of a relative relationship between a location where the power supply device 12 is installed and a location where the power receiving device 13 is installed. The information indicative of a relative relationship between a location where the power supply device 12 is installed and a location where the power receiving device 13 is installed is, for example, coordinates indicating the locations of the power supply device 12 and the power receiving device 13, or information on an angle (for example, elevation angle and rotation angle) from the power supply device 12 with respect to the power receiving device 13.

In the example shown in FIG. 2, a power receiving device ID “1” assigned to the first power receiving device 13-1 is associated with location information p1. A power receiving device ID “2” assigned to the second power receiving device 13-2 is associated with location information p2. A power receiving device ID “N” assigned to the Nth power receiving device 13-N is associated with location information pN.

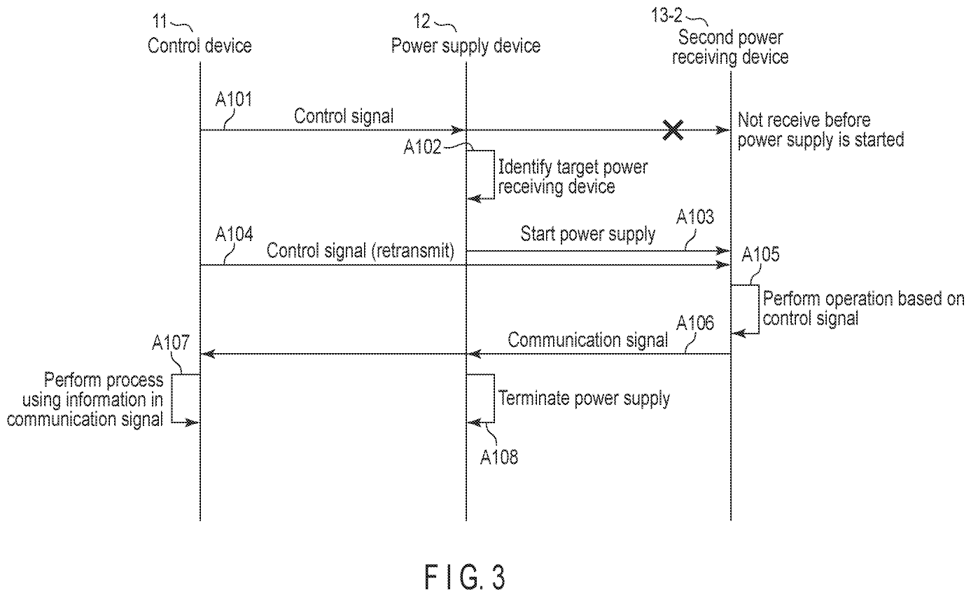

Next, with reference to FIGS. 3 to 5, some examples of a control operation performed in the power supply system 1A will be described. The control operation is an operation for supplying power to a power receiving device 13 and causing the power receiving device 13 to perform a specific operation. The control operation is performed when at least one of the power receiving devices 13 is to be operated.

FIG. 3 is a sequence diagram showing a first example of the control operation performed in the power receiving system 1A. Here, a case where the power receiving device 13 to be operated is the second power receiving device 13-2 and the second power receiving device 13-2 does not include a battery will be described.

First, the control device 11 transmits the control signal 21 containing information indicative of the second power receiving device 13-2, and the power supply device 12 receives the control signal 21 (A101). Note that the second power receiving device 13-2 does not receive the control signal 21 because power is not being supplied to the second power receiving device 13-2 from the power supply device 12 and the second power receiving device 13-2 is not driven.

The power supply device 12 identifies the second power receiving device 13-2 as a target power receiving device 13, based on the received control signal 21 (A102). Specifically, the power supply device 12 acquires the location information corresponding to the second power receiving device 13-2, based on information in the control signal 21 that indicates the second power receiving device 13-2. The power supply device 12 acquires, for example, the location information associated with the power receiving device ID of the second power receiving device 13-2 from the power supply device information table 124A.

The power supply device 12 then starts transmitting the power transmission signal 31 (that is, supplying power) to the identified second power receiving device 13-2 (A103). Specifically, the power supply device 12 transmits, for example, the power transmission signal 31 directional to the second power receiving device 13-2 (for example, with maximum directivity) by using the acquired location information of the second power receiving device 13-2. The second power receiving device 13-2 is driven in response to reception of the power transmission signal 31.

Next, the control device 11 retransmits the control signal 21 since the control device 11 has not received a response to the control signal 21 from the second power receiving device 13-2 (A104). Note that the timing at which the control device 11 retransmits the control signal 21 may be controlled by the power supply device 12. In that case, the power supply device 12 transmits a signal to the control device 11 to wait for retransmission of the control signal 21 (hereinafter, also referred to as a standby signal) until it starts supplying power to the second power receiving device 13-2 in A103 after receiving the control signal 21 in A101, for example. Alternatively, the power supply device 12, not the control device 11, may transmit the control signal 21 to the second power receiving device 13-2. That is, the power supply device 12 may transmit the control signal 21 received in A101 to the second power receiving device 13-2 after starting to supply power to the second power receiving device 13-2.

The second power receiving device 13-2 driven by the power transmission signal 31 receives the retransmitted control signal 21 and performs the specific operation based on the control signal 21 (A105). The specific operation is, for example, a predetermined operation. Alternatively, the specific operation may be an operation designated by information in the control signal 21. Specifically, the specific operation is, for example, at least one of a sensing operation, a display operation, or an operation to generate information based on an external input (for example, operation by a user). In a case where the display operation is performed, the control signal 21 may further contain information on a content to be displayed. The second power receiving device 13-2 transmits the communication signal 22 containing information on the specific operation performed (A106). The information on the specific operation is, for example, sensor data acquired by the sensing operation or the information generated based on the external input.

The control device 11 receives the communication signal 22 from the second power receiving device 13-2 and performs a process using the information in the communication signal 22 (A107). Specifically, the control device 11 uses the information in the communication signal 22 to perform, for example, a process to store the sensor data, a process to confirm that the external input has been obtained correctly, or the like.

Further, the power supply device 12 receives the communication signal 22 from the second power receiving device 13-2 and terminates transmission of the power transmission signal 31 to the second power receiving device 13-2 (A108). In other words, the power supply device 12 terminates transmission of the power transmission signal 31 by using the communication signal 22 corresponding to the control signal 21 as a trigger. Thus, the driving of the second power receiving device 13-2 is terminated.

With the above-described control operation, the power supply device 12 can supply power to the second power receiving device 13-2 at a high antenna gain without receiving, from the second power receiving device 13-2, information necessary for power supply. The information necessary for power supply is, for example, the location information of the second power receiving device 13-2.

If the second power receiving device 13-2 transmits the location information to the power supply device 12, the second power receiving device 13-2 needs to have a battery to drive a communication unit, which transmits the location information, before the power supply device 12 supplies power.

In contrast, the power supply device 12 of the embodiment identifies the target second power receiving device 13-2 based on the control signal 21 transmitted from the control device 11 and acquires the location information of the second power receiving device 13-2 from the power supply information table 124A. Thus, the second power receiving device 13-2 does not need to transmit the location information. Further, the second power receiving device 13-2 does not need to have the battery to drive the communication unit, which transmits the location information, before power is supplied from the power supply device 12. Therefore, in the power supply system 1A, the second power receiving device 13-2 can be downsized and the cost of it can be reduced.

Note that the above-provided example is explained in connection with the case where the target power receiving device 13 is the second power receiving device 13-2, but a similar control operation is performed for a case where the target power receiving device 13 is another power receiving device 13 (for example, the first power receiving device 13-1, or the Nth power receiving device 13-N). Thus, similarly for the other power receiving devices 13, the power supply device 12 can supply power to each of the power receiving devices 13 at a high antenna gain without receiving, from each of the power receiving devices 13, information necessary for power supply. Further, the other power receiving devices 13 do not need to have batteries, and they can be downsized and the cost of them can be reduced.

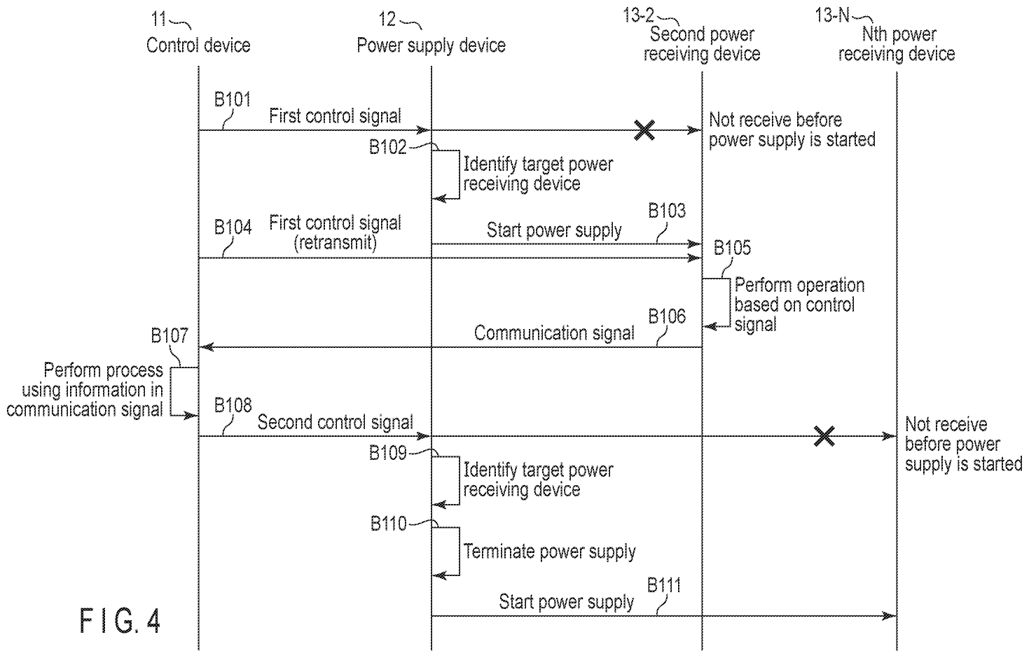

FIG. 4 is a sequence diagram showing a second example of the control operation performed in the power supply system 1A. Here, a case where the second power receiving device 13-2 is operated and then the Nth power receiving device 13-N is operated. Note that it is assumed that each of the second power receiving device 13-2 and the Nth power receiving device 13-N does not include a battery.

The procedure from B101 to B107 is similar to the procedure from A101 to A107 of the control operation described above with reference to FIG. 3. In other words, between the control device 11, the power supply device 12, and the second power receiving device 13-2, the procedure for supplying power to the second power receiving device 13-2 and causing the second power receiving device 13-2 to perform the specific operation is performed. Note that in the example shown in FIG. 4, the control signal 21 that contains information indicative of the second power receiving device 13-2 (that is, the control signal 21 transmitted in B101 and B104) is referred to as a first control signal 21.

Next, the control device 11 transmits a second control signal 21 that contains information indicative of the Nth power receiving device 13-N since the operation regarding the second power receiving device 13-2 has been completed, and the power supply device 12 receives the second control signal 21 (B108). Note that the Nth power receiving device 13-N does not receive the second control signal 21 because power is not being supplied to the Nth power receiving device 13-N from the power supply device 12 and the Nth power receiving device 13-N is not driven. In addition, even if the second power receiving device 13-2 has received the second control signal 21, the second power receiving device 13-2 ignores (discards) the second control signal 21 since the second control signal 21 designates the Nth power receiving device 13-N.

The power supply device 12 identifies the Nth power receiving device 13-N as a target power receiving device 13, based on the second control signal 21 received from the control device 11 (B109). Specifically, the power supply device 12 acquires location information corresponding to the Nth power receiving device 13-N on the basis of information in the second control signal 21 that indicates the Nth power receiving device 13-N. Further, the power supply device 12 terminates transmission of the power transmission signal 31 to the second power receiving device 13-2, based on the second control signal 21 (B110). Specifically, the power supply device 12 terminates transmission of the power transmission signal 31 to the second power receiving device 13-2, for example, based on the fact that the second control signal 21 designates the Nth power receiving device 13-N that is different from the second power receiving device 13-2. As a result, driving of the second power receiving device 13-2 is terminated.

The power supply device 12 then starts transmitting a power transmission signal 31 to the identified Nth power receiving device 13-N (B111). Specifically, the power supply device 12 transmits, for example, the power transmission signal 31 directional to the Nth power receiving device 13-N by using the acquired location information of the Nth power receiving device 13-N. The Nth power receiving device 13-N is driven in response to reception of the power transmission signal 31. The subsequent procedure is similar to the procedure from B104 to B107, and therefore the operation in which the second power receiving device 13-2 is replaced by the Nth power receiving device 13-N is performed.

Thus, the power supply device 12 may terminate power supply to the second power receiving device 13-2 by using the second control signal 21 from the control device 11 as a trigger, in place of the communication signal 22 from the second power receiving device 13-2.

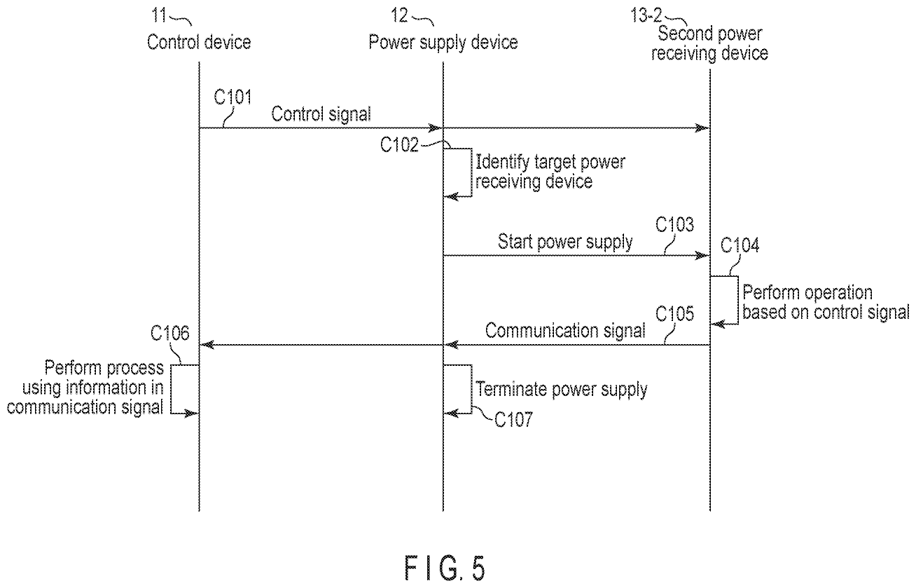

FIG. 5 is a sequence diagram showing a third example of the control operation performed in the power supply system 1A. Here, a case where the power receiving device 13 to be operated is the second power receiving device 13-2 and the second power receiving device 13-2 includes a battery will be described.

First, the control device 11 transmits the control signal 21 that contains information indicative of the second power receiving device 13-2, and the power supply device 12 and the second power receiving device 13-2 receive the control signal 21 (C101). The second power receiving device 13-2 receives the control signal 21 since it is driven by power supplied from the battery.

The power supply device 12 identifies the second power receiving device 13-2 as a target power receiving device 13, based on the received control signal 21 (C102). The power supply device 12 then starts transmitting the power transmission signal 31 to the identified second power receiving device 13-2 (C103).

The subsequent procedure from C104 to C107 is similar to the procedure from A105 to A108 of the control operation described above with reference to FIG. 3. In other words, in the example shown in FIG. 5, since the second power receiving device 13-2 receives the control signal 21 in C101, the control device 11 does not need to retransmit the control signal 21 after the power supply device 12 starts power supply to the second power receiving device 13-2.

As in the case of the example shown in FIG. 4, the power supply device 12 may terminate power supply to the second power receiving device 13-2 in response to receiving, from the control device 11, the control signal 21 that designates a power receiving device 13 other than the second power receiving device 13-2, in place of the communication signal 22 transmitted from the second power receiving device 13-2.

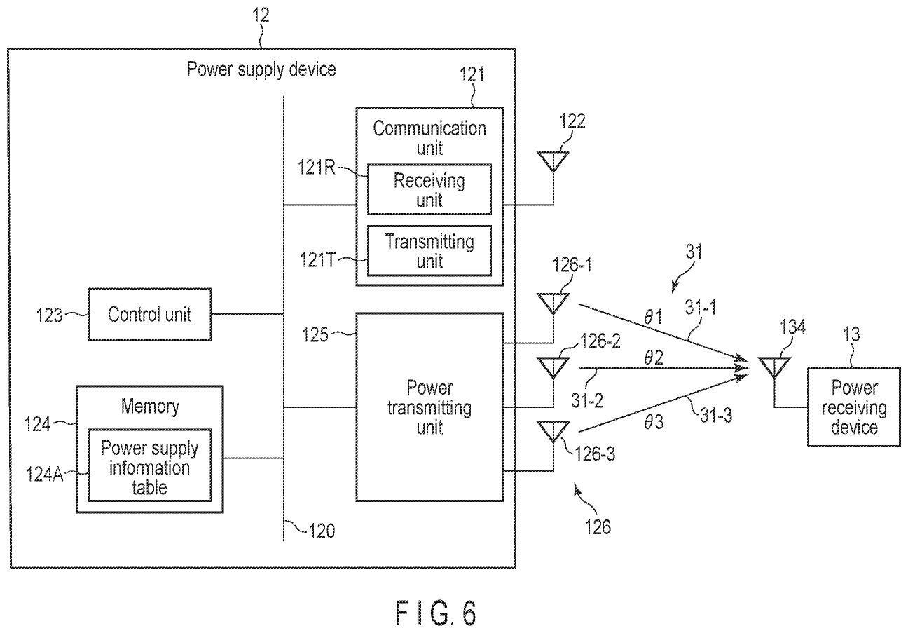

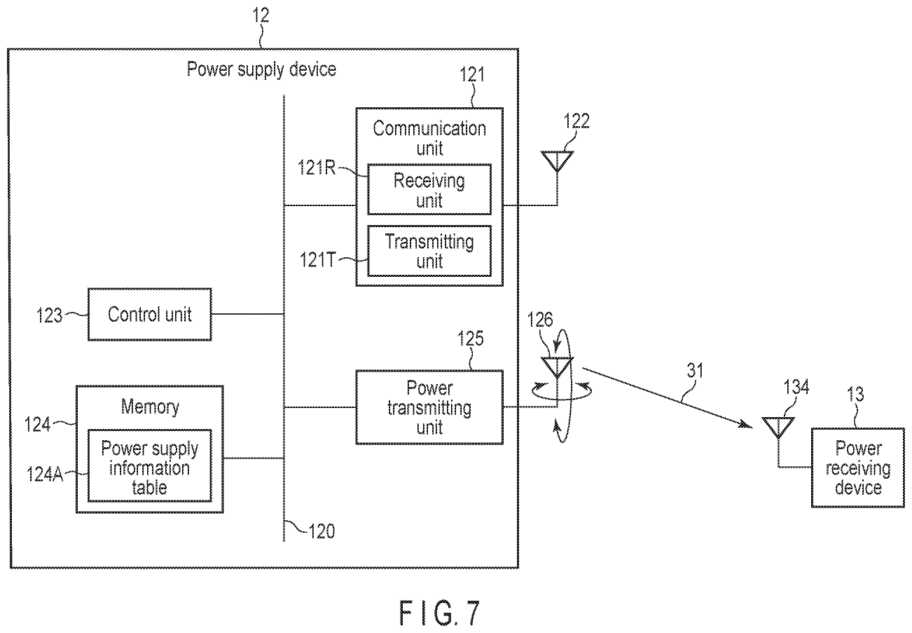

Next, with reference to FIGS. 6 and 7, a configuration example of the power supply device 12 will be specifically explained.

FIG. 6 shows a first example of a configuration of the power supply device 12. In the first example, the power supply device 12 transmits the power transmission signal 31 to the power receiving device 13 by directivity control using beamforming.

The power supply device 12 includes a communication unit 121, a communication antenna 122, a control unit 123, a memory 124, a power transmitting unit 125, and power transmitting antennas (antenna elements) 126. The communication unit 121, the control unit 123, the memory 124, and the power transmitting unit 125 are connected to each other via, for example, a bus 120. The memory 124 is a memory area and stores, for example, the power supplying information table 124A.

The communication unit 121 is a circuit which is capable of transmitting and receiving signals for communication via the communication antenna 122. The communication unit 121 includes a receiving unit 121R and a transmitting unit 121T.

The receiving unit 121R is a circuit that is capable of receiving a signal transmitted by the control device 11 and a signal transmitted by the power receiving devices 13, via the communication antenna 122. The signal transmitted by the control device 11 is, for example, the control signal 21. The signal transmitted by each of the power receiving devices 13 is, for example, the communication signal 22. The receiving unit 121R may send the received signal to each unit (for example, the control unit 123) of the power supply device 12. The receiving unit 121R receives the signal in accordance with an instruction by the control unit 123, for example.

The transmitting unit 121T is a circuit that is capable of transmitting a signal to the control device 11 and the power receiving devices 13 via the communication antenna 122. The signal transmitted to the control device 11 is, for example, the standby signal. The signal transmitted to the power receiving device 13 is, for example, the control signal 21. The transmitting unit 121T transmits the signal in accordance with an instruction by the control unit 123, for example.

The control unit 123 is a circuit that controls an operation of each unit of the power supply device 12. The control unit 123 is realized, for example, as one or more processors. The control unit 123 controls, for example, power supply by the power transmitting unit 125 on the basis of the control signal 21 received from the communication unit 121 (more particularly, the receiving unit 121R).

Specifically, the control unit 123 identifies a target power receiving device 13 based on the control signal 21. For example, the control unit 123 identifies the target power receiving device 13 by acquiring a power receiving device ID from the control signal 21.

The control unit 123 then acquires location information associated with the target power receiving device 13 (that is, location information associated with the acquired power receiving device ID) from the power supply information table 124A. The location information indicates, for example, a relative positional relationship between the power supply device 12 and the target power receiving device 13. Based on the acquired location information, the control unit 123 determines an angle (or direction) at which the maximum directivity of electromagnetic waves radiated from the power transmitting antennas 126 is to be controlled. That is, the control unit 123 determines the angle at which the maximum directivity of electromagnetic waves to be controlled so that the electromagnetic waves highly directional to the target power receiving device 13 are radiated from the power transmitting antennas 126, based on the acquired location information. The control unit 123 sends the determined angle to the power transmitting unit 125.

The power transmitting unit 125 is a circuit that receives, from the control unit 123, the angle at which the maximum directivity of electromagnetic waves is to be controlled and transmits power transmission signals 31 based on the received angle via the power transmitting antennas 126. Specifically, the power transmitting unit 125 generates transmission signals 31 that are supplied to the power transmitting antennas 126, respectively, based on the angle at which the maximum directivity of electromagnetic waves is to be controlled. Based on the angle at which the maximum directivity of electromagnetic waves is to be controlled, the power transmitting unit 125 determines, for example, a phase θ and an amplitude A of each of the power transmission signals 31, and generates the power transmission signals 31 each having the determined phase θ and amplitude A. The power transmitting unit 125 then sends the generated power transmission signals 31 to the power transmitting antennas 126, respectively. In this way, the power transmitting unit 125 controls the directivity of the transmission signals 31 by beamforming using the transmission antennas 126 on the basis of the positional relationship between the power supply device 12 and the target power receiving device 13. Note that the phase θ and the amplitude A may be determined (calculated) by the control unit 123, or the phase θ and the amplitude A calculated in advance may be acquired from the power supply information table 124A. In this case, the power transmitting unit 125 receives not the angle, but the phase θ and the amplitude A from the control unit 123.

Each of the power transmitting antennas 126 radiates the power transmission signal 31 received from the power transmitting unit 125. The power transmitting antennas 126 radiate the power transmission signals 31 from which the maximum gain is obtained at the target power receiving device 13.

The target power receiving device 13 receives the transmission signals 31 via a power receiving antenna 134. Therefore, the power supply device 12 can supply power at a high antenna gain to the target power receiving device 13, based on the control signal 21 received from the control device 11.

Note that FIG. 6 shows, as an example, a case where the power transmitting antennas 126 are three power transmitting antennas 126-1, 126-2, and 126-3. In this case, based on the angle at which the maximum directivity of electromagnetic waves is to be controlled, the power transmitting unit 125 determines three combinations of a phase and an amplitude including θ1 and A1, θ2 and A2, and θ3 and A3 that correspond to three transmission signals 31-1, 31-2, and 31-3, respectively. The power transmitting unit 125 generates the power transmission signal 31-1 having θ1 and A1, the power transmission signal 31-2 having θ2 And A2, and the power transmission signal 31-3 having θ3 and A3. The power transmitting unit 125 then sends the generated power transmission signals 31-1, 31-2, and 31-3 to the power transmitting antennas 126-1, 126-2, and 126-3, respectively.

The power supply device 12 includes two or more transmitting antennas 126. Note that a common antenna may be used for the communication antenna 122 and the power transmitting antenna 126.

Further, the control unit 123 may instruct the power transmitting unit 125 to terminate power supply, based on the communication signal 22 that is received from the communication unit 121 while the power transmitting unit 125 supplies power. Alternatively, the control unit 123 may instruct the power transmitting unit 125 to terminate power supply, based on a new control signal 21 that is received from the communication unit 121 while the power transmitting unit 125 supplies power. Or termination/stop of the power supply may be instructed when an impact on other radio equipment or human body occurs. The new control signal 21 is a control signal that designates, as a target of power supply, a power receiving device 13 other than the target power receiving device 13 to which the power transmitting unit 125 currently supplies power. The power transmitting unit 125 terminates power supply (that is, transmitting of the power transmission signals 31) in response to the instruction by the control unit 123 to terminate power supply.

After receiving the control signal 21 from the communication unit 121, the control unit 123 may instruct the communication unit 121 (more specifically, the transmission unit 121T) to transmit a signal (standby signal) for waiting for retransmission of the control signal 21 until power supply by the transmission unit 125 is started. The communication unit 121 transmits the standby signal to the control device 11 in response to this instruction.

Alternatively, after receiving the control signal 21 from the communication unit 121, the control unit 123 may instruct the communication unit 121 to transmit this control signal 21 in response to start of power supply by the power transmitting unit 125. The communication unit 121 transmits the control signal 21 to the target power receiving device 13 in response to this instruction.

With the above-described configuration, the power supply device 12 controls the directivity of the power transmission signals 31 (that is, electromagnetic waves) by beamforming, based on the control signal 21 received from the control device 11. Thus, the power supply device 12 can supply power at high antenna gain to the target power receiving device 13.

FIG. 7 shows a second example of the configuration of the power supply device 12. In the second example, the power supply device 12 transmits a power transmission signal 31 to the power receiving device 13 by mechanical control of one power transmitting antenna 126. The configuration of the power supply device 12 shown in FIG. 7 is similar to that of the power supply device 12 shown in FIG. 6, except for the configuration of the power transmitting unit 125 and the power transmitting antenna 126. Hereinafter, the difference from the configuration of the power supply device 12 shown in FIG. 6 will be mainly explained.

The power supply device 12 shown in FIG. 7 includes, for example, the power transmitting antenna 126. This power transmitting antenna 126 is configured such that the direction (for example, elevation angle and rotation angle) is mechanically controllable. For the mechanical control, for example, a stepper motor, a servo motor or the like, that is connected to the power transmitting antenna 126 is used.

The power transmitting unit 125 receives, from the control unit 123, a direction in which the maximum directivity of electromagnetic waves radiated from the power transmitting antenna 126 is to be controlled. The power transmitting unit 125 calculates an elevation angle and a rotation angle of the power transmitting antenna 126, based on the received direction. The power transmitting unit 125 then mechanically controls the power transmitting antenna 126 so that it is set to the calculated elevation angle and rotation angle. Further, the power transmitting unit 125 generates a power transmission signal 31 to be supplied to the power transmitting antenna 126 and sends the generated transmission signal 31 to the power transmitting antenna 126. In this way, the power transmitting unit 125 controls the directivity of the power transmission signal 31 by mechanically controlling the angle of the power transmitting antenna 126 on the basis of the positional relationship between the power supply device 12 and the target power receiving device 13. Note that the elevation angle and the rotation angle of the power transmitting antenna 126 may be determined by the control unit 123, or the elevation angle and the rotation angle calculated in advance may be acquired from the power supply information table 124A. In this case, the power transmitting unit 125 receives not the direction, but the elevation angle and the rotation angle from the control unit 123.

After the elevation angle and the rotation angle are mechanically controlled, the power transmitting antenna 126 radiates the power transmission signal 31 received from the power transmitting unit 125. In other words, the power transmitting antenna 126 radiates the power transmission signal 31 from which the maximum gain is obtained at the target power receiving device 13.

The target power receiving device 13 receives the power transmission signal 31 via the power receiving antenna 134. Therefore, the power supply device 12 can supply power to the power receiving device 13 at a high antenna gain.

With the above-described configuration, the power supply device 12 controls the directivity of the power transmission signal 31 by mechanically controlling the power transmitting antenna 126 on the basis of the control signal 21 received from the control device 11. As a result, the power supply device 12 can supply power at a high antenna gain to the target power receiving device 13.

Note that the operations in the power supply device 12 described above may be realized as hardware, such as circuitry, or as a program (that is, software) executed by at least one processor. For example, the control unit 123 may control the communication unit 121 and the power transmitting unit 125 by executing a program stored in the memory 124 or the like to realize the operations in the power supply device 12 described above. For example, the control unit 123 executing the program causes the communication unit 121 to receive the control signal 21 from the control device 11 and causes the power transmitting unit 125 to transmit the power transmission signal 31 to the power receiving device 13 based on information in the control signal 21 that designates the power receiving device 13. Thus, the power supply device 12 may have a function of a computer executing the program.

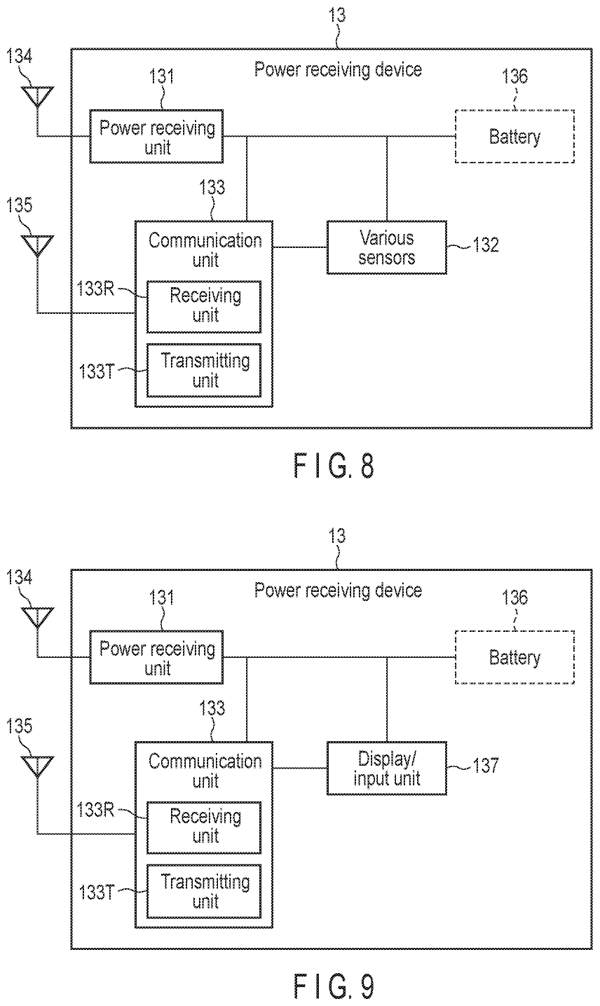

Next, with reference to FIGS. 8 and 9, a configuration example of the power receiving device 13 will be specifically explained.

FIG. 8 shows a first example of a configuration of the power receiving device 13. Here, an example in which the power receiving device 13 is realized as a sensing device will be described.

The power receiving device 13 includes a power receiving unit 131, a power receiving antenna 134, a communication unit 133, a communication antenna 135, and a sensor unit 132.

The power receiving unit 131 is a circuit that receives a power transmission signal 31 via the power receiving antenna 134, converts power of the received power transmission signal 31 into direct-current power, and supplies the converted power to each unit of the power receiving device 13. By the supplied power, for example, the communication unit 133 and the sensor unit 132 are driven.

The communication unit 133 is a circuit which is capable of transmitting and receiving a signal for communication via the communication antenna 135. The communication unit 133 includes a receiving unit 133R and a transmitting unit 133T.

The receiving unit 133R is a circuit that is capable of receiving a signal transmitted by the control device 11 and a signal transmitted by the power supply device 12, via the communication antenna 135. The signal transmitted by the control device 11 and the signal transmitted by the power supply device 12 are, for example, a control signal 21. The receiving unit 133R may send the received signal to each unit (for example, the sensor unit 132) of the power receiving device 13.

The transmitting unit 133T is a circuit that is capable of transmitting a signal to the control device 11 and the power supply device 12 via the communication antenna 135. The signal transmitted to the control device 11 and the power supply device 12 is, for example, a communication signal 22. The transmitting unit 133T transmits the signal, for example, in accordance with an instruction by the sensor unit 132.

The sensor unit 132 performs a first operation based on the control signal 21 received from the communication unit 133 (more particularly, the receiving unit 133R). The first operation is, for example, an operation that includes at least one of generating sensor data or instructing the communication unit 133 to transmit the generated or accumulated sensor data. The sensor unit 132 senses physical or chemical information at a location where the power receiving device 13 is installed and generates sensor data. The sensor unit 132 may store (accumulate) the generated sensor data in any memory area in the power receiving device 13. The sensor unit 132 performs the first operation when the sensor unit 132 is driven by power supplied from the power receiving unit 131 and the control signal 21 received from the communication unit 133 contains information designating this power receiving device 13, for example.

When the sensor unit 132 instructs the communication unit 133 to transmit the sensor data, the communication unit 133 (more specifically, the transmission unit 133T) transmits the communication signal 22 containing the sensor data via the communication antenna 135. A common antenna may be used for the communication antenna 135 and the receiving antenna 134.

The control device 11 receives the communication signal 22 transmitted from the power receiving device 13. Therefore, the control device 11 can cause the power receiving device 13 designated in the control signal 21 to perform the first operation and acquire the sensor data generated by the power receiving device 13.

Note that the power supply device 12 may receive the communication signal 22 transmitted from the power receiving device 13. In this case, the power supply device 12 may terminate power supply to the power receiving device 13, based on the received communication signal 22.

The power receiving device 13 may further include a battery 136. In this case, the communication unit 133 and the sensor unit 132 may be driven by power supplied from the battery 136 while power is not being supplied by the power receiving device 12. The driven sensor unit 132 may generate sensor data and store it in any memory area. The battery 136 may be charged with power supplied by the power supply device 12 (that is, power of the power transmission signal 31 supplied by the power receiving unit 131).

FIG. 9 shows a second example of the configuration of the power receiving device 13. Here, an example in which the power receiving device 13 is realized as a display/input device will be described. The display/input device is, for example, a pickup display device. The configuration of the power receiving device 13 shown in FIG. 9 is similar to that of the power receiving device 13 shown in FIG. 8, except that the sensor unit 132 is replaced by a display/input unit 137. Hereinafter, the difference from the configuration of the power receiving device 13 shown in FIG. 8 will be explained.

The power receiving unit 131 supplies power of the power transmission signal 31 received from the power supply device 12 to, for example, the communication unit 133 and the display/input unit 137.

The communication unit 133 sends the control signal 21 received from the control device 11 to the display/input unit 137.

The display/input unit 137 includes a display section that displays (notifies) information to a user and an input section that receives an external input. The display section is a device that provides visual notification to the user, such as a display or an LED. The input section is a device that has a user-operable interface, such as a button, and generates information in response to user's operation. The user is, for example, an operator who uses the pickup display device.

The display/input unit 137 performs a second operation, based on the control signal 21 received from the communication unit 133. The second operation is, for example, an operation that includes at least one of displaying information or instructing the communication unit 133 to transmit information generated based on an external input (an operation by the user). For example, when the control signal 21 contains information on a content to be displayed, the display/input unit 137 displays the content based on the information on a screen of the display. The display/input unit 137 performs the second operation when the display/input unit 137 is driven by power supplied from the power receiving unit 131 and the control signal 21 received from the communication unit 133 contains information designating this power receiving device 13, for example.

It is assumed, for example, that the display/input unit 137 includes an LED, an LED control circuit, and an input information generation circuit having a button. The LED control circuit controls turning on and off of the LED. The input information generation circuit receives an operation made by the user and generates information based on the received operation. More specifically, the input information generating circuit generates information based on, for example, an operation by the user pressing down the button.

In this case, the display/input unit 137 turns on the LED in response to receiving the control signal 21. The display/input unit 137 generates specific information when the user has pressed down the button while the LED is being lit. The specific information indicates, for example, that there has been a change in the external input, that the user has pressed down the button, or that the second operation has been correctly performed. The display/input unit 137 then instructs the communication unit 133 to transmit the generated specific information. Further, the display/input unit 137 turns off the LED when the user has pressed down the button while the LED is being lit.

When the display/input unit 137 has instructed the communication unit 133 to transmit the specific information, the communication unit 133 transmits the communication signal 22 containing the specific information via the communication antenna 135.

The control device 11 receives the communication signal 22 transmitted from the power receiving device 13. Thus, the control device 11 can cause the power receiving device 13 designated in the control signal 21 to perform the second operation and acquire the specific information generated by the power receiving device 13. Based on the acquired specific information, the control device 11 can confirm, for example, that the second operation has been performed in the designated power receiving device 13.

Thus, the power receiving device 13 can receive power from the power supply device 12 without transmitting, to the control device 11 or the power supply device 12, information necessary for power supply. Therefore, the power receiving device 13 does not need to include a battery to drive the communication unit, which transmits location information, before power is supplied by the power supply device 12. Therefore, in the power supply system 1A, the power receiving device 13 can be downsized and the cost of it can be reduced. Note that the power receiving device 13 may include either a display-related configuration (the display section) or an input-related configuration (the input section) of the display/input unit 137.

### Second Embodiment

In the first embodiment, the power supply system 1A includes the control device 11, the power supply device 12, and the power receiving devices 13. By contrast, in a second embodiment, a power supply system 1B includes by a power supply device 12B including a control device 11B and the power receiving devices 13.

A configuration of the power supply system 1B of the second embodiment is similar to that of the power supply system 1A of the first embodiment, except that the control device 11B is included in the power supply device 12B. In the following descriptions, the difference from the first embodiment will be mainly explained.

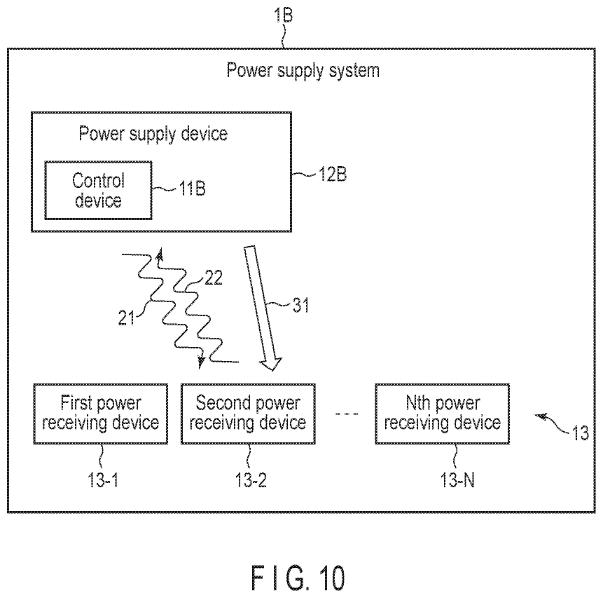

FIG. 10 shows a configuration example of the power supply system 1B that includes the power supply device 12A of the second embodiment.

The power supply device 12B has a configuration similar to that described above with reference to FIG. 6 or FIG. 7, for example, and further includes the control device 11B.

The control device 11B is connected to each unit (for example, the control unit 123) of the power supply device 12B via an internal bus, for example. The control device 11B transmits a control signal 21 to the power receiving device 13 and sends the control signal 21 to the control unit 123 via the internal bus.

The control unit 123 receives the control signal 21 from the control device 11B. Accordingly, the control unit 123 can identify a target power receiving device 13 by using the received control signal 21 and send a power transmission signal 31 to the identified power receiving device 13.

The other operations of the control device 11B and the power supply device 12B and the operations of the power receiving device 13 are as described above in the first embodiment.

Thus, the control device 11B may be included in the power supply device 12B. Including the control device 11B in the power supply device 12B enables the whole of the power supply device system 1B to be downsized and the cost of it can be reduced.

### Third Embodiment

In the first embodiment, the power supply system 1A includes the control device 11, the power supply device 12, and the plurality of power receiving devices 13. By contrast, in a third embodiment, a plurality of power supply areas are provided and the power supply device 12 is provided for each of the power supply areas.

A configuration of a power supply system 1C of the third embodiment is similar to that of the power supply system 1A of the first embodiment, except that the power supply device 12 is provided in each of the power supply areas. In the following descriptions, the difference from the first embodiment will be mainly explained.

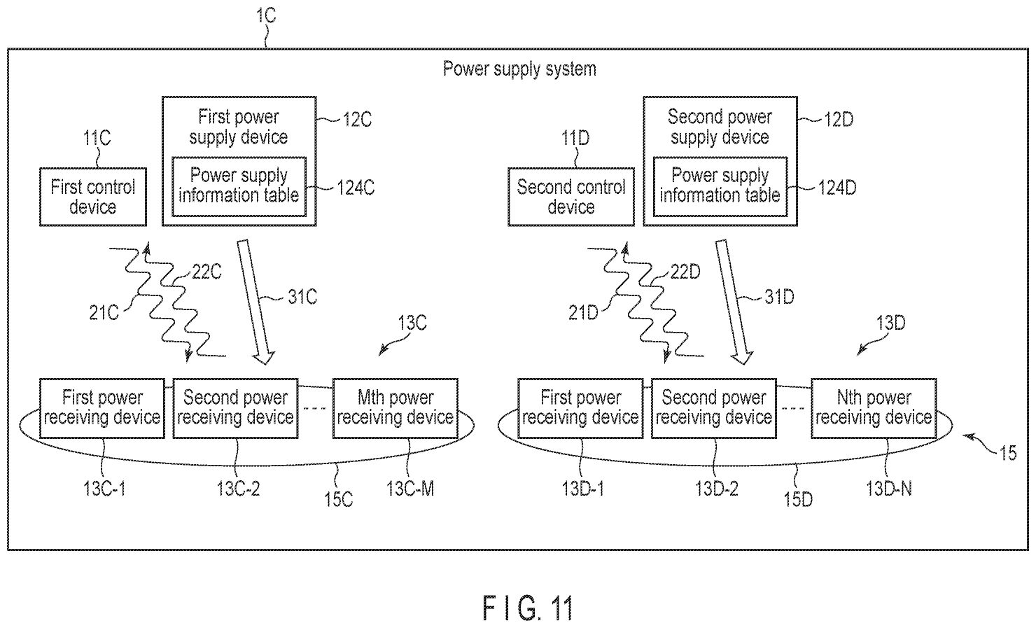

FIG. 11 shows a configuration example of the power supply system 1C that includes a power supply device 12C and a power supply device 12D according to the third embodiment. Here, an example in which the power supply system 1C is configured for two power supply areas 15 will be described. The two power supply areas 15 are a first power supply area 15C and a second power supply area 15D. For each of the two power supply areas 15, one power supply device 12C or 12D is provided. Note that the power supply system 1C may be configured for three or more power supply areas 15.

The power supply system 1C includes, for example, a first control device 11C, the first power supply device 12C, M power receiving devices 13C, a second control device 11D, the second power supply device 12D, and N power receiving devices 13D, where M is an integer of two or more.

The M power receiving devices 13C are installed in the first power supply area 15C. The M power receiving devices 13C include power receiving devices 13C-1, 13C-2, . . . , and 13C-M. Hereinafter, one unspecified power receiving device among the M power receiving devices 13C may be referred to as a power receiving device 13C.

The N power receiving devices 13D are installed in the second power supply area 15D. The N power receiving devices 13D include power receiving devices 13D-1, 13D-2, . . . , and 13D-N. Hereinafter, one unspecified power receiving device among the N power receiving devices 13D may be referred to as a power receiving device 13D.

The first power supply area 15C and the second power supply area 15D are physically different zones. The number of power receiving devices 13C installed in the first supplying area 15C may be equal to or different from the number of power receiving devices 13D installed in the second supplying area 15D.

The first control device 11C and the first power receiving device 12C are provided for the first power supply area 15C. In more detail, the first control device 11C and the first power supply device 12C are configured to control each of the M power receiving devices 13C in the first power supply area 15C as a target of power supply and an operation.

The first control device 11C is a device configured to control an operation of the first power supply device 12C and an operation of each of the M power receiving devices 13C. Specifically, the first control device 11C informs the first power supply device 12C and the power receiving devices 13C of a power receiving device 13C that is a target of power supply and an operation (i.e., a target power receiving device 13C), and controls the operation of the target power receiving device 13C and the operation of the first power supply device 12C. The first control device 11C transmits a control signal 21C to inform the first power supply device 12C and the power receiving devices 13C of the target power receiving device 13C. The control signal 21C is a radio signal that contains information designating one of the M power receiving devices 13C.

The first power supply device 12C is a device that transmits a power transmission signal 31C to the target power receiving device 13C based on the control signal 21C. The power transmission signal 31C is a wireless signal that supplies power to the target power receiving device 13C. The first power supply device 12C stores a power supply information table 124C. The power supply information table 124C is data that contains location information of each of the M power receiving devices 13C. The first power supply device 12C acquires the location information of the power receiving device 13C designated in the control signal 21C (that is, the target power receiving device 13C) from the power supply device information table 124C. The first power supply device 12C transmits the power transmission signal 31C highly directional to the target power receiving device 13C, based on the acquired location information.

The power receiving device 13C is a device that is driven using power of the power transmission signal 31C transmitted from the first power supply device 12C and performs a specific operation based on the control signal 21C. The power receiving device 13C may transmit a communication signal 22C in the specific operation. The communication signal 22C is a wireless signal containing information on the specific operation.

The second control device 11D and the second power receiving device 12D are provided for the second power supply area 15D. In more detail, the second control device 11D and the second power supply device 12D are configured to control each of the N power receiving devices 13D in the second power supply area 15D as a target of power supply and an operation.

The second control device 11D is a device that controls an operation of the second power supply device 12D and an operation of each of the N power receiving devices 13D. Specifically, the second control device 11D informs the second power supply device 12D and the power receiving devices 13D of a power receiving device 13D that is a target of power supply and an operation (i.e., a target power receiving device 13D) and controls the operation of the target power receiving device 13D and the operation of the second power supply device 12D. The second control device 11D transmits a control signal 21D to inform the second power supply device 12D and the power receiving devices 13D of the target power receiving device 13D. The control signal 21D is a radio signal that contains information designating one of the N power receiving devices 13D.

The second power supply device 12D is a device that transmits a power transmission signal 31D to the target power receiving device 13D based on the control signal 21D. The power transmission signal 31D is a wireless signal that supplies power to the target power receiving device 13D. The second power supply device 12D stores a power supply information table 124D. The power supply information table 124D is data that includes location information of each of the N power receiving devices 13D. The second power supply device 12D acquires the location information of the power receiving device 13D designated in the control signal 21D (that is, the target power receiving device 13D) from the power supply information table 124D. The second power supply device 12D transmits the power transmission signal 31D highly directional to the target power receiving device 13D, based on the acquired location information.

The power receiving device 13D is a device that is driven using power of the power transmission signal 31D transmitted from the second power supply device 12D and performs a specific operation based on the control signal 21D. The power receiving device 13D may transmit a communication signal 22D in the specific operation. The communication signal 22D is a wireless signal containing information on the specific operation.

Note that the first power supply device 12C may receive the control signal 21D transmitted by the second control device 11D. When the first power supply device 12C has received the control signal 21D designating a power receiving device 13D in the second power supply area 15D that is different from the corresponding first power supply area 15C, the first power supply device 12C does not perform power supply according to this control signal 21D. Specifically, the first power supply device 12C does not perform power supply according to the control signal 21D since, for example, the power receiving device 13D (more precisely, the power receiving device ID) designated in the control signal 21D is not included in the power supply information table 124C. In other words, the first power supply device 12C is configured to supply power to the power receiving devices 13C in the corresponding first power supply area 15C and not to supply power to the power receiving devices 13 in the other power supply area 15 (here, the power receiving devices 13D in the second power supply area 15D).

Similarly, the second power supply device 12D may receive the control signal 21C transmitted by the first control device 11C. When the second power supply device 12D has received the control signal 21C designating a power receiving device 13C in the first power supply area 15C that is different from the corresponding second power supply area 15D, the second power supply device 12D does not perform power supply according to this control signal 21C. Specifically, the second power supply device 12D does not perform power supply according to the control signal 21C since, for example, the power receiving device 13C designated in the control signal 21C is not included in the power supply information table 124D. In other words, the second power supply device 12D is configured to perform power supply to the power receiving devices 13D in the corresponding second power supply area 15D and not to perform power supply to the power receiving devices 13 in the other power supply area 15 (here, the power receiving devices 13C in the first power supply area 15C).

FIG. 11 illustrates a case where the target power receiving device 13C in the first power supply area 15C is the second power receiving device 13C-2 and the target power receiving device 13D in the second power supply area 15D is the second power receiving device 13D-2. In this case, the first control device 11C transmits the control signal 21C containing information that designates the second power receiving device 13C-2, and the second control device 11D transmits the control signal 21D containing information that designates the second power receiving device 13D-2.

The first power supply device 12C receives the control signal 21C from the first control device 11C and acquires the location information of the second power receiving device 13C-2 from the power supply information table 124C. The first power supply device 12C then transmits the power transmission signal 31C highly directional to the second power receiving device 13C-2, based on the acquired location information. Further, even if the first power supply device 12C has received the control signal 21D from the second control device 11D, the first power supply device 12C does not perform any operation related to power supply.

The second power receiving device 13C-2 receives the power transmission signal 31C highly directional to the second power receiving device 13C-2. The second power receiving device 13C-2 is then driven by power of the received transmission signal 31C. Further, the second power receiving device 13C-2 receives the control signal 21C from the first control device 11C and performs a specific operation. The second power receiving device 13C-2 then transmits the communication signal 22C containing information on the specific operation.

The second power supply device 12D receives the control signal 21D from the second control device 11D and acquires the location information of the second power receiving device 13D-2 from the power supply information table 124D. The second power supply device 12D then transmits the power transmission signal 31D highly directional to the second power receiving device 13D-2, based on the acquired location information. Further, even if the second power supply device 12D has received the control signal 21C from the first control device 11C, the second power supply device 12D does not perform any operation related to power supply.

The second power receiving device 13D-2 receives the power transmission signal 31D highly directional to the second power receiving device 13D-2. The second power receiving device 13D-2 is then driven by power of the received transmission signal 31D. Further, the second power receiving device 13D-2 receives the control signal 21D from the second control device 11D and performs a specific operation. The second power receiving device 13D-2 then transmits the communication signal 22D that contains information on the specific operation.

With the above-described configuration, the first power supply device 12C can perform power supply at high antenna gain to the power receiving device 13C designated in the control signal 21C by using the control signal 21C transmitted from the first control device 11C and the power supply information table 124C stored in the first power supply device 12C without receiving, from the power receiving device 13C, information necessary for power supply. Further, the second power supply device 12D can perform power supply at high antenna gain to the power receiving device 13D designated in the control signal 21D by using the control signal 21D transmitted from the second control device 11D and the power supply information table 124D stored in the second power supply device 12D without receiving, from the power receiving device 13D, information necessary for power supply.

Furthermore, in the power supply system 1C, in the case where there are the plurality of power supply areas 15, each of the power supply devices 12C and 12D can avoid performing power supply to the power receiving devices 13 in other power supply areas 15 that receive lower power by the power supply. Thus, in the power supply system 1C, the influence on other radio signals that is caused by directional strength occurring in an unexpected direction, can be reduced.

Note that the power supply system 1C may include one control device 11 in place of the two control devices 11C and 11D. In this case, the control device 11 controls the operation of the first power supply device 12C, the operation of each of the M power receiving devices 13C, the operation of the second power supply device 12D, and the operation of each of the N power receiving devices 13D. The control device 11 is capable of transmitting the control signal 21C and the control signal 21D.

Specifically, the control device 11 informs the first power supply device 12C and the power receiving devices 13C of the target power receiving device 13C, and controls the operation of the target power receiving device 13C and the operation of the first power supply device 12C. The control device 11 transmits the control signal 21C so as to inform the first power supply device 12C and the power receiving devices 13C of the target power supply device 13C.

Further, the control device 11 informs the first power supply device 12D and the power receiving devices 13D of the target power receiving device 13D, and controls the operation of the target power receiving device 13D and the operation of the second power supply device 12D. The control device 11 transmits the control signal 21D so as to inform the second power supply device 12D and the power receiving devices 13D of the target power receiving device 13D.

In the case where the power supply system 1C includes the control device 11, each of the power supply devices 12C and 12D can avoid performing power supply to the power receiving devices 13 in other power supply areas 15 that receive lower power by the power supply.

As explained above, according to the first to third embodiments, power can be supplied to a power receiving device 13 without receiving, from the power receiving device 13, information necessary for power supply. The receiving unit 121R of the power supply device 12 receives, from the control device 11, a first control signal 21 including first information which designates a first power receiving device 13 among a plurality of power receiving devices 13. The power transmitting unit 125 transmits a wireless power transmission signal 31 for power supply to the first power receiving device 13, based on the first information. The first control signal 21 is a signal that causes the first power receiving device 13 to perform a specific operation.

As described above, the power supply device 12 can supply power to the first power receiving device 13 without receiving, from the first power receiving device 13, information necessary for power supply (for example, location information of the first power receiving device 13).

Note that the configurations of the power supply systems 1A, 1B, and 1C can as well be applied to cases where beamforming and mechanical control for high-speed communications which require a high signal-to-noise ratio (S/N ratio) are used. In this case, high power signals can be sent to a specific power receiving target (power receiving device), which is advantageous in improving the S/N ratio.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

With respect to the above-described embodiments, the following additional remarks are further disclosed.

<1> A power supply device comprising:
a receiving unit configured to receive, from a control device, a first control signal including first information that designates a first power receiving device of a plurality of power receiving devices; and
a power transmitting unit configured to transmit a wireless power transmission signal for power supply to the first power receiving device, based on the first information, wherein
the first control signal is a signal which causes the first power receiving device to perform a specific operation.

<2> The power supply device of item <1>, wherein
the first information includes an identification code by which the first power receiving device is identifiable.

<3> The power supply device of item <1> or <2>, wherein
the power transmitting unit is configured to control directivity of the wireless power transmission signal by beamforming using antennas or by mechanically controlling an angle of an antenna, based on a positional relationship between the power supply device and the first power receiving device.

<4> The power supply device of item <3>, wherein
the power transmitting unit is configured to: acquire location information on a relative positional relationship between the power supply device and the first power receiving device; and
control the directivity of the wireless power transmission signal by beamforming using the antennas or by mechanically controlling the angle of the antenna, based on the location information.

<5> The power supply device of one of items <1> to <5>, wherein
the power supply device includes the control unit.

<6> The power supply device of one of items <1> to <5>, wherein
in a case where a plurality of power receiving devices are installed in each of a plurality of power supply areas, the power supply device is provided for each of the power supply areas.

<7> The power supply device of one of items <1> to <6>, further comprising:
a transmission unit configured to transmit, to the control device, a signal to control a timing of retransmitting the first control signal.

<8> The power supply device of one of items <1> to <6>, further comprising:
a transmission unit configured to transmit the first control signal to the first power receiving device after transmission of the wireless power transmission signal is started.

<9> The power supply device of one of items <1> to <8>, wherein
the receiving unit is configured to receive a second control signal from the control device after receiving the first control signal, the second control signal including second information which designates a second power receiving device of the plurality of power receiving devices, and
the power transmitting unit is configured to terminate transmission of the wireless power transmission signal, based on the received second control signal.

<10> The power supply device of one of items <1> to <8>, wherein
the first control signal is a signal which causes the first power receiving device to perform the specific operation and then transmit a communication signal that includes second information on the specific operation,
the receiving unit is configured to receive the communication signal from the first power receiving device, and
the power supply device is configured to terminate transmission of the wireless power transmission signal, based on the received communication signal.

<11> A power supply system comprising a control device, a power supply device, and a plurality of power receiving devices, wherein
the control device is configured to transmit a control signal including first information that designates a first power receiving device of the plurality of power receiving devices,
the power supply device is configured to:
   receive the control signal; and
   transmit a wireless power transmission signal for power supply to the first power receiving device, based on the first information in the received control signal, and
the first power receiving device is configured to:
   receive the wireless power transmission signal;
   receive the control signal; and
   perform a specific operation based on the received control signal.

<12> The power supply system of item <11>, wherein
the first power receiving device
   includes a sensor, and
   is configured to perform the specific operation and transmit a communication signal including second information acquired by the sensor, based on the received control signal.

<13> The power supply system of item <11>, wherein
the first power receiving device includes a display unit,
the control signal further includes third information on a content to be displayed on the display unit, and
the first power receiving device is configured to display the content based on the third information on the display unit.

<14> The power supply system of item <11>, wherein
the first power receiving device
   includes an input unit, and
   performs a specific operation based on the received control signal and transmits a communication signal containing second information generated by the input unit in response to an operation by the user.

<15> A non-transitory computer-readable storage medium having stored thereon a computer program which is executable by a computer, the computer program comprising instructions capable of causing the computer to execute functions of:
receiving, from a control device, a first control signal including first information that designates a first power receiving device of a plurality of power receiving devices; and
transmitting a wireless power transmission signal for power supply to the first power receiving device based on the first information, wherein
the first control signal is a signal which causes the first power receiving device to perform a specific operation.

<16> The power supply device of one of items <1> to <10>, wherein
the first power receiving device is a sensing device, and
the specific operation is an operation to sense physical or chemical information at an installation location.

<17> The power supply device of one of items <1> to <10>, wherein
the first power receiving device is a display device, and
the specific operation is to display information or to light up.

<18> The power supply device of one of items <1> to <10>, wherein
the first control signal is a signal that causes the first power receiving device to perform the specific operation and then transmit a communication signal including second information on the specific operation.

What is claimed is:

1. A power supply device comprising:
a receiving unit configured to receive, from a control device, a first control signal including first information that designates a first power receiving device of a plurality of power receiving devices; and
a power transmitting unit configured to transmit a wireless power transmission signal for power supply to the first power receiving device, based on the first information; wherein
the first control signal is a signal which causes the first power receiving device to perform a specific operation.

2. The power supply device of claim 1, wherein
the first information includes an identification code by which the first power receiving device is identifiable.

3. The power supply device of claim 1, wherein
the power transmitting unit is configured to control directivity of the wireless power transmission signal by beamforming using antennas or by mechanically controlling an angle of an antenna, based on a positional relationship between the power supply device and the first power receiving device.

4. The power supply device of claim 3, wherein
the power transmitting unit is configured to:
acquire location information on a relative positional relationship between the power supply device and the first power receiving device; and
control the directivity of the wireless power transmission signal by beamforming using the antennas or by mechanically controlling the angle of the antenna, based on the location information.

5. The power supply device of claim 1, wherein
the power supply device includes the control device.

6. The power supply device of claim 1, wherein
in a case where a plurality of power receiving devices are installed in each of a plurality of power supply areas, the power supply device is provided for each of the power supply areas.

7. The power supply device of claim 1, further comprising:
a transmission unit configured to transmit, to the control device, a signal to control a timing of retransmitting the first control signal.

8. The power supply device of claim 1, further comprising:
a transmission unit configured to transmit the first control signal to the first power receiving device after transmission of the wireless power transmission signal is started.

9. The power supply device of claim 1, wherein
the receiving unit is configured to receive a second control signal from the control device after receiving the first control signal, the second control signal including second information which designates a second power receiving device of the plurality of power receiving devices, and
the power transmitting unit is configured to terminate transmission of the wireless power transmission signal, based on the received second control signal.

10. The power supply device of claim 1, wherein
the first control signal is a signal which causes the first power receiving device to perform the specific operation and then transmit a communication signal that includes second information on the specific operation,
the receiving unit is configured to receive the communication signal from the first power receiving device, and
the power supply device is configured to terminate transmission of the wireless power transmission signal, based on the received communication signal.

11. A power supply system comprising a control device, a power supply device, and a plurality of power receiving devices, wherein
the control device is configured to transmit a control signal including first information that designates a first power receiving device of the plurality of power receiving devices,
the power supply device is configured to:
receive the control signal; and
transmit a wireless power transmission signal for power supply to the first power receiving device, based on the first information in the received control signal, and
the first power receiving device is configured to:
receive the wireless power transmission signal;
receive the control signal; and
perform a specific operation based on the received control signal.

12. The power supply system of claim 11, wherein
the first power receiving device
includes a sensor, and
is configured to perform the specific operation and transmit a communication signal including second information acquired by the sensor, based on the received control signal.

13. The power supply system of claim 11, wherein
the first power receiving device includes a display unit,
the control signal further includes third information on a content to be displayed on the display unit, and
the first power receiving device is configured to display the content based on the third information on the display unit.

14. The power supply system of claim 11, wherein
the first power receiving device
includes an input unit, and
is configured to perform the specific operation and transmit a communication signal including second information that is generated by the input unit in response to an operation by a user, based on the received control signal.

15. A non-transitory computer-readable storage medium having stored thereon a computer program which is executable by a computer, the computer program comprising instructions capable of causing the computer to execute functions of:
receiving, from a control device, a first control signal including first information that designates a first power receiving device of a plurality of power receiving devices; and
transmitting a wireless power transmission signal for power supply to the first power receiving device based on the first information, wherein
the first control signal is a signal which causes the first power receiving device to perform a specific operation.

16. The power supply device of claim 1, wherein
the first power receiving device is a sensing device, and
the specific operation is an operation to sense physical or chemical information at an installation location.

17. The power supply device of claim 1, wherein
the first power receiving device is a display device, and
the specific operation is to display information or to light up.

18. The power supply device of claim 1, wherein
the first control signal is a signal that causes the first power receiving device to perform the specific operation and then transmit a communication signal including second information on the specific operation.
